(19) United States
(12) Patent Application Publication
(10) Pub. No.: US 2017/0177813 A1
(43) Pub. Date: Jun. 22, 2017

(54) SYSTEM AND METHOD FOR RECOMMENDING ANALYTIC MODULES BASED ON LEADING FACTORS CONTRIBUTING TO A CATEGORY OF CONCERN

(71) Applicant: XEROX CORPORATION, Norwalk, CT (US)

(72) Inventors: Jinhui Yao, Pittsford, NY (US); Jing Zhou, Pittsford, NY (US); Michael D. Shepherd, Ontario, NY (US); Lina Fu, Fairport, NY (US); Faming Li, Solon, OH (US); Dennis F. Quebe, JR., Austin, TX (US); Jennie Echols, Cumming, GA (US); Xuejin Wen, Airport, NY (US)

(21) Appl. No.: 14/978,611

(22) Filed: Dec. 22, 2015

(51) Int. Cl. G06F 19/00; G06F 17/27; G06F 17/22; G06F 17/28

(52) U.S. Cl. CPC G06F 19/345; G06F 17/28; G06F 17/2715; G06F 17/2211

(57) ABSTRACT

A computer system configured to improve health outcomes and reduce medical service costs includes a memory storing a computer program and a processor that executes the computer program. The computer program receives a medical inquiry, extracts a keyword using natural language processing (NLP), selects a category of concern indicated by the medical inquiry from a library using the keyword, determines leading factors contributing to the category of concern based on a statistical model analysis, selects analytic modules from a library that receive at least one of the leading factors as an input parameter or produce at least one of the leading factors as an output parameter, and generates a recommendation including a listing of the selected analytic modules and/or a constructed workflow including at least two of the selected analytic modules chained together via respective input parameters and output parameters of the at least two selected analytic modules.

### BACKGROUND

1. Technical Field

Exemplary embodiments of the present disclosure relate to systems and methods generally related to healthcare analytics, and more particularly, to systems and methods for recommending analytic modules and/or analytic workflows based on leading factors contributing to a category of concern to improve health outcomes and manage healthcare costs.

2. Discussion of Related Art

Currently, there is a trend in U.S. State Medicaid offices to transition their members from a fee-for-service payment model to a managed care payment model. The Centers for Medicare and Medicaid Services (CMS) dictates that states provide better oversight of Managed Care Organizations (MCOs). Insights into patient data require automated processes so that Medicaid directors can easily understand how each MCO and healthcare provider is performing from clinical, financial, and operational perspectives. Current analysis and workflow tools are manually driven, and require a Medicaid officer to spend many hours or days of analysis to answer a single question about their member population.

Medicaid requirements on the MCOs and healthcare providers include requests to generate hundreds of detailed reports for the Medicaid offices to process. Medicaid offices, in turn, generate hundreds of detailed reports for the federal CMS office. Typically, these reports are manually processed and scoured for opportunities to improve health outcomes and improve effective spending on Medicaid populations. In addition, Medicaid offices continuously track encounter claims to determine MCO reimbursement and set capitation rates.

### SUMMARY

According to aspects illustrated herein, an exemplary embodiment of the present disclosure provides a computer system configured to perform at least one of improving a health outcome and reducing a medical service cost of a Managed Care Organization (MCO). The computer system includes a memory storing a computer program and a processor configured to execute the computer program. The computer program is configured to receive a medical inquiry from a user in real-time. The medical inquiry includes text data. The computer program is further configured to extract at least one keyword from the text data using natural language processing (NLP), transmit the at least one keyword to a predetermined library of categories of concern, compare the at least one keyword with a plurality of existing categories of concern stored in the predetermined library of categories of concern to select an existing category of concern indicated by the medical inquiry from the predetermined library of categories of concern, determine leading factors contributing to the selected category of concern based on a statistical model analysis, select analytic modules from a predetermined library of analytic modules that receive at least one of the leading factors as an input parameter or produce at least one of the leading factors as an output parameter, and generate a recommendation. The recommendation includes at least one of a listing of the selected analytic modules and a constructed workflow including at least two of the selected analytic modules chained together via respective input parameters and output parameters of the at least two selected analytic modules.

According to aspects illustrated herein, an exemplary embodiment of the present disclosure provides a computer system configured to perform at least one of improving a health outcome and reducing a medical service cost of a Managed Care Organization (MCO). The computer system includes a memory storing a computer program and a processor configured to execute the computer program. The computer program is configured to receive a medical inquiry from a user in real-time, compare one or more keywords of the medical inquiry with a plurality of existing categories of concern stored in a categories of concern library to select a category of concern indicated by the medical inquiry, select leading factors contributing to the selected category of concern from among a plurality of existing contributing factors stored in a contributing factors library based on a statistical model analysis, select analytic modules from a predetermined library of analytic modules that receive at least one of the leading factors as an input parameter or produce at least one of the leading factors as an output parameter, and generate a recommendation. The recommendation includes at least one of a listing of the selected analytic modules and a constructed workflow including at least two of the selected analytic modules chained together via respective input parameters and output parameters of the at least two selected analytic modules.

According to aspects illustrated herein, an exemplary embodiment of the present disclosure provides a computer system configured to perform at least one of improving a health outcome and reducing a medical service cost of a Managed Care Organization (MCO). The computer system includes a memory storing a computer program and a processor configured to execute the computer program. The computer program is configured to receive an inquiry from a user in real-time, identify a category of concern indicated by the inquiry using natural language processing (NLP), determine leading factors contributing to the category of concern based on a statistical model analysis, select analytic modules from a predetermined library of analytic modules that receive at least one of the leading factors as an input parameter or produce at least one of the leading factors as an output parameter, and generate a recommendation including at least one of a listing of the selected analytic modules and a constructed workflow including at least two of the selected analytic modules chained together via respective input parameters and output parameters of the at least two selected analytic modules.

### BRIEF DESCRIPTION OF THE DRAWINGS

The above and other features of the present disclosure will become more apparent by describing in detail exemplary embodiments thereof with reference to the accompanying drawings, in which:

FIG. 1 is a block diagram of a network for communication between a computer and a database, according to exemplary embodiments of the present disclosure.

FIG. 2 is a block diagram showing a general overview of a process of recommending analytic modules and/or analytic workflows based on leading factors relevant to a medical inquiry, according to exemplary embodiments of the present disclosure.

FIG. 3 is a flow diagram showing a method of recommending analytic modules and/or analytic workflows based on leading factors relevant to a medical inquiry, according to exemplary embodiments of the present disclosure.

FIG. 4 is a flow diagram showing a process of determining leading factors contributing to a category of concern, according to an exemplary embodiment of the present disclosure.

FIG. 5 shows an example of a recommendation provided in response to a medical inquiry, according to exemplary embodiments of the present disclosure.

FIG. 6 is a schematic diagram illustrating a device used to implement exemplary embodiments of the present disclosure.

FIG. 7 is a schematic diagram illustrating a system used to implement exemplary embodiments of the present disclosure.

FIG. 8 shows an exemplary graphical user interface (GUI) accessible to a user according to an exemplary embodiment of the present disclosure.

### DETAILED DESCRIPTION

Exemplary embodiments of the present disclosure will be described more fully hereinafter with reference to the accompanying drawings. Like reference numerals may refer to like elements throughout the accompanying drawings. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

### GLOSSARY

As used herein, the following terms are understood to have the following meanings:

member: any person enrolled in a Managed Care Organization (MCO).

healthcare provider: an entity that provides a medical service. Examples of healthcare providers include an endocrinologist providing endocrinology services, a psychiatrist providing psychiatry services, a gastroenterologist providing gastroenterology services, a dermatologist providing dermatology services, a neurologist providing neurology services, an orthopedic doctor providing orthopedics services, an ENT providing otology services, an ophthalmologist providing ophthalmology services, an oncologist providing oncology services, etc.

medical inquiry: an inquiry made by a medical expert such as, for example, a medical expert at an MCO-monitoring organization (e.g., a Medicaid office), a doctor, a nurse, etc. A medical inquiry is an inquiry relating to a common issue of interest in the medical field, and more particularly, to a common issue of interest to an MCO-monitoring organization. The medical inquiry is submitted in the form of a natural language question. Examples of medical inquiries include “why is the re-admission so high?”, “how often are patients visiting an emergency room?”, “why is the readmission rate higher in the month of April compared to other months?”, “how does the level of care for men in their forties compare to the level of care for men in their sixties?”, “are patients with heart disease receiving adequate service?”, etc. The medical inquiry may be provided via a variety of input means. For example, the medical inquiry may be text data input to a graphical user interface (GUI) by the medical expert via a keyboard, voice data input by the medical expert via a microphone, etc.

category of concern: a collection of character strings (e.g., words, phrases, etc.) defined by a medical domain expert corresponding to an area of interest that indicates to an MCO-monitoring organization (e.g., a Medicaid office) the effectiveness and efficiency of an MCO being monitored. A category of concern is an area of interest that has a significant impact on both the cost of providing care and the quality of care provided by an MCO being monitored. Examples of common categories of concern include “emergency department utilization”, “hospital re-admissions”, “demographic disparity in care”, “service utilization by members with chronic conditions”, etc. Each medical inquiry entered by a medical expert has an underlying category of concern. For example, entry of the medical inquiry “how often are patients visiting an emergency room?” may result in the identification of a category of concern entitled “emergency department utilization”, entry of the user inquiry “why is the readmission rate higher in the month of April compared to other months?” may result in the identification of a category of concern entitled “hospital readmissions”, entry of the user inquiry “how does the level of care for men in their forties compare to the level of care for men in their sixties?” may result in the identification of a category of concern entitled “demographic disparity in care”, and entry of the user inquiry “are patients with heart disease receiving adequate service?” may result in the identification of a category of concern entitled “chronic condition service utilization.”

analytic module: a predefined algorithm that addresses a specific category of concern. A plurality of predefined analytic modules may be stored in a library in an electronic database. An analytic module receives leading factors as input parameters and produces leading factors as output parameters based an analysis performed using the input parameters. The output corresponds to specific, relevant findings for the corresponding category of concern. The output is either a concrete recommendation provided to the medical expert, or is data that may be used to perform further analysis (e.g., using additional analytic modules) to subsequently provide a concrete recommendation to a user. An example of an analytic module is an analytic module that calculates the ratio of avoidable-to-non-avoidable emergency department visits for various populations, and examples of a concrete recommendation output by an analytic module include adding incentives for the creation of additional care facilities, and encouraging members to move from one MCO with insufficient pediatricians to another MCO that provides improved access to care.

leading factors: a collection of character strings (e.g., words, phrases, etc.) corresponding to variables that are input to and output from a particular analytic module that contributes significantly to the category of concern corresponding to that particular analytic module. The leading factors input to and output from a particular analytic module have a high correlation to the category of concern corresponding to that particular analytic module, and thus, provide insight regarding that category of concern. As an example, leading factors that contribute to an analytic module corresponding to a readmission rate category of concern may include the type of disease of the patient, the age of the patient, the ethnicity of the patient, and the geographic location of the patient.

contributing factors: includes all leading factors corresponding to all analytic modules. For example, if analytic module A includes leading factors a and b as inputs/outputs, analytic module B includes leading factors c and d as inputs/outputs, and analytic module C includes leading factors e, f and g as input/outputs, the contributing factors include all factors a, b, c, d, e, f and g.

constructed workflow: a composition of analytic modules including at least two analytic modules chained together (e.g., connected to each other) via respective input parameters and output parameters of the at least two selected analytic modules. For example, analytic module A that outputs parameter x may be chained to analytic module B that receives parameter x as an input, and analytic module B that outputs parameter y may be chained to analytic module C that receives parameter y as an input. Analytic modules A, B and C constitute a constructed workflow. A constructed workflow utilizes a plurality of related analytic modules to provide an output responsive to a specific complex medical inquiry which may not otherwise be addressable by a single analytic module.

recommendation: a collection (e.g., an unordered listing) of analytic modules and/or a collection of constructed workflows capable of providing a concrete recommendation responsive to a medical expert's medical inquiry that is provided to the medical expert. The recommendation provides the medical expert with a collection of analytic modules and/or constructed workflows that may be used by the medical expert to obtain a concrete recommendation responsive to the medical expert's medical inquiry, as opposed to providing the medical expert with the concrete recommendation itself. For example, upon receiving a medical inquiry “why is the readmission rate so high?”, rather than providing the medical expert with a proposed solution to lower the re-admission rate (e.g., a concrete recommendation), the recommendation may provide the medical expert with a listing of algorithms A, B, C, D and E, and a constructed workflow including algorithm A linked to algorithm C, and algorithm C linked to algorithm E.

Exemplary embodiments of the present disclosure provide decision support systems and methods capable of automatically providing descriptive, predictive, and prescriptive insights based on healthcare encounter claims data and other related data. Exemplary embodiments utilize analytic modules (also referred to as analytic algorithms) to solve problems in various areas of concern of a medical organization such as, for example, Medicaid offices and other organizations that monitor the efficiency and effectiveness of Managed Care Organizations (MCOs).

According to exemplary embodiments of the present disclosure, systems and methods provide a framework of searching analytic module libraries stored in a computer database to more efficiently identify and recommend an analytic module(s) and/or an analytic workflow(s) that provides insight relating to a specific category of concern indicated by a medical inquiry received from a user. Herein, a medical inquiry made by a user may refer to an inquiry made by a medical expert at an MCO-monitoring organization including, for example, a Medicaid office. MCO-monitoring organizations typically have various categories of concern which are used by the organization to closely track the effectiveness and efficiency of MCOs. The categories of concern have a significant impact on both the cost of providing care and to the quality of care provided. Examples of common categories of concern include emergency department utilization, hospital re-admissions, demographic disparity in care, service utilization by members with chronic conditions, etc. Exemplary embodiments of the present disclosure utilize analytic modules to provide a response to a medical inquiry relating to a specific category of concern.

Analytic modules address a specific category of concern in healthcare for an MCO-monitoring organization. Each analytic module determines a set of relevant findings based on medical data. The basis of these findings leads to further analysis or a selection of recommendations. For example, each analytic module generates as an output specific, relevant findings for a particular category of concern of MCO-monitoring organizations. The output of each analytic module corresponds to either a concrete recommendation that is provided to a user (e.g., a medical expert at an MCO-monitoring organization) or corresponds to information that may be used to perform further analysis to subsequently provide a concrete recommendation to a user. Examples of a concrete recommendation output by an analytic module may include adding incentives for the creation of additional care facilities, encouraging members to move from one MCO with insufficient pediatricians to another MCO that provides improved access to care, etc. Exemplary embodiments of the present disclosure are directed at generating a recommendation indicating to a user which analytic module(s) and/or analytic workflow(s) are capable of providing a concrete recommendation responsive to a user's medical inquiry (i.e., as opposed to generating a recommendation that is the concrete recommendation itself). The analytic modules may be grouped into analytic libraries corresponding to an area of concern.

Regarding the performance of further analysis using the analytic modules, the output of one analytic module may be provided as an input to another analytic module relating to the same category of concern. This process is referred to as constructing an analytic workflow, which includes a plurality of analytic modules chained together, and is described in further detail below. After a full analytic workflow is performed, recommendations may be provided for improved population healthcare outcomes and healthcare costs. A system according to exemplary embodiments may automatically select and execute a recommended analytic module(s) to provide an outcome to a user.

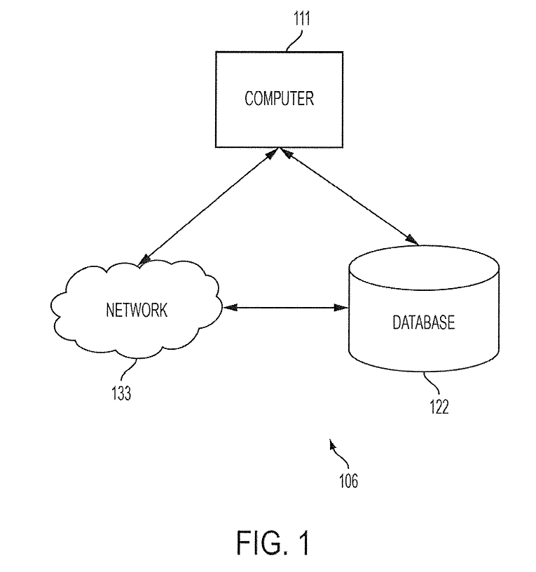

FIG. 1 shows a general overview of a network, indicated generally as 106, for communication between a computer system 111 and a database 122. The computer system 111 may include any form of processor as described in further detail below. The computer system 111 can be programmed with appropriate application software, which can be stored in a memory of the computer system 111, and which implements the methods described herein. Alternatively, the computer system 111 is a special purpose machine that is specialized for processing healthcare data and includes a dedicated processor that would not operate like a general purpose processor because the dedicated processor has application specific integrated circuits (ASICs) that are specialized for the handling of medical data processing operations (e.g., medical claims), processing analytic modules and workflows, tracking services provided by MCOs, etc. In one example, the computer system 111 is a special purpose machine that includes a specialized processing card having unique ASICs for identifying analytic modules and constructing analytic workflows, includes specialized boards having unique ASICs for input and output devices to increase the speed of network communications processing, a specialized ASIC processor that performs the logic of the methods described herein using dedicated unique hardware, logic circuits, etc.

The database 122 includes any database or any set of records or data that the computer system 111 desires to retrieve. The database 122 may be any organized collection of data operating with any type of database management system. The database 122 may contain matrices of datasets including multi-relational data elements. All libraries of data described herein may be included the database 122, or in multiple databases 122. For example, a predetermined library of analytic modules, a predetermined library of categories of concern, and a contributing factors library, as discussed in detail below, may be included in the database 122 or in multiple databases 122.

The database 122 may communicate with the computer system 111 directly. Alternatively, the database 122 may communicate with the computer system 111 over the network 133. The network 133 includes a communication network for affecting communication between the computer system 111 and the database 122. For example, the network 133 may include a local area network (LAN) or a global computer network, such as the Internet.

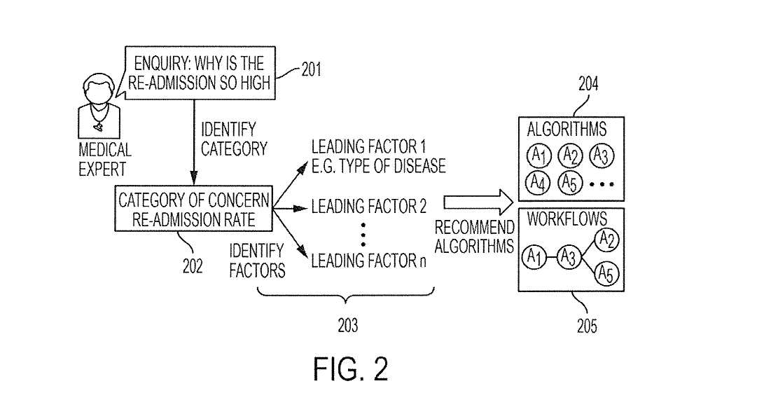

FIG. 2 shows a general overview of a process of recommending analytic modules (also referred to as analytic algorithms) and/or analytic workflows based on the leading factors relevant to a user's medical inquiry, according to exemplary embodiments of the present disclosure.

Referring to FIG. 2, a user (e.g., a medical expert at an MCO-monitoring organization) submits an inquiry (201). In FIG. 2, the exemplary inquiry relates to determining why a re-admission rate is high. A category of concern indicated by the user's inquiry is then identified (202). For example, in FIG. 2, based on the exemplary inquiry “why is the re-admission so high,” it is determined that the category of concern is “re-admission rate.” Upon identifying the category of concern, leading factors that contribute significantly to the category of concern are identified (203). These factors correspond to variables such as, for example, a patient age group, geographic location, patient ethnicity, etc. Analytic modules and/or analytic workflows that use the identified leading factors as an input(s) or produce the identified leading factors an output(s) are then identified and provided as output to the user (204, 205).

Since the leading factors have a high correlation to the category of concern of the inquiry, analysis relating to the leading factors provides insight regarding the category of concern. For example, referring to FIG. 2, since it is known that the type of disease that a patient is suffering from has a high correlation with re-admission rate (e.g., it is known that patients with certain diseases are more likely to return to a medical facility), an analytic module designed to investigate the seasonal patterns of a certain disease may reveal answers regarding peaks in the re-admission rate.

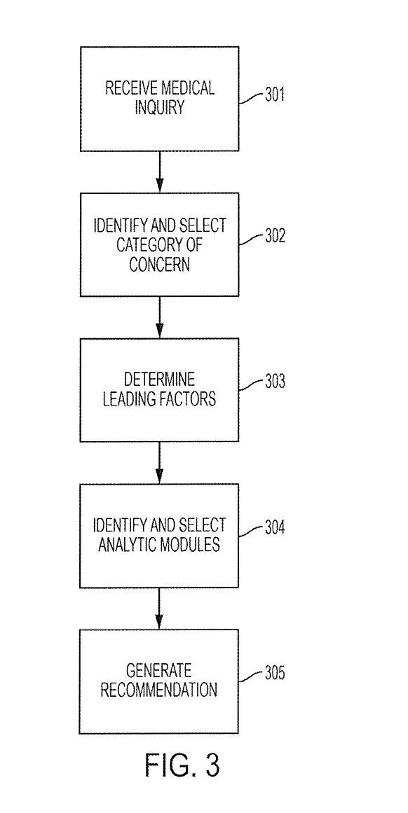

FIG. 3 is a flow diagram showing a method of recommending analytic modules and/or analytic workflows based on the leading factors relevant to a user's inquiry, according to exemplary embodiments of the present disclosure.

A medical inquiry is received at block 301. The medical inquiry is submitted in the form of a natural language question by a user (e.g., a medical expert at an MCO-monitoring organization). An example of a medical inquiry is “why is the re-admission so high?” as described above with reference to FIG. 2. The medical inquiry may be provided via a variety of input means. For example, the medical inquiry may be text data input to a graphical user interface (GUI) by the user via a keyboard, voice data input by the user via a microphone, etc. Herein, the term medical inquiry refers to any inquiry made be a user relating to issues (e.g., common issues of interest) in the medical field, and more particularly, to common issues of interest to an MCO-monitoring organization such as a Medicaid office. Examples of medical inquiries include “how often are patients visiting an emergency room?”, “why is the readmission rate higher in the month of April compared to other months?”, “how does the level of care for men in their forties compare to the level of care for men in their sixties?”, “are patients with heart disease receiving adequate service?”, etc.

At block 302, a category of concern that is indicated by the medical inquiry is identified and selected, for example, from a predetermined library of categories of concern. The category of concern may be identified using, for example, any one of a variety of Natural Language Processing (NLP) processes. For example, as described above, the medical inquiry may be text data input to a graphical user interface (GUI) by the user via a keyboard, voice data input by the user via a microphone, etc. If the medical inquiry is not text data (i.e., if the medical inquiry is voice data input via a microphone), the medical inquiry is converted into text data. Herein, when a medical inquiry is referred to as including text data, it is understood that the medical inquiry was either originally received as text data (i.e., by being input to a GUI by the user via a keyboard), or has been converted into text data after being received via another input means (i.e., by being input via a microphone by the user). An NLP process is utilized to identify a category of concern that the medical inquiry is related to. For example, at least one keyword from the text data of the medical inquiry may be extracted using NLP. The at least one keyword may then be transmitted to a predetermined library of categories of concern, and the at least one keyword may then be compared with the existing categories of concern stored in the library to select an existing category of concern indicated by the medical inquiry.

In an exemplary embodiment, each category of concern corresponds to a predetermined library of analytic modules, which may be stored in an electronic database. A keyword-based NLP process may be used to search the predetermined library of categories of concern, as described above, to identify any categories of concern that include certain keywords that are also included in the medical inquiry, or that include certain keywords that are not explicitly included in the medical inquiry but are linked to words in the medical inquiry. For example, although the medical inquiry “are patients with heart disease receiving adequate service?” does not include the word “chronic” in the medical inquiry, the words “heart disease” may be linked to the word “chronic” since heart disease is a chronic illness. Linked words may be implemented by storing a list of linked words in the predetermined library of categories of concern, or in another library accessible by the predetermined library of categories of concern.

The categories of concern stored in the predetermined library are a collection of character strings (e.g., words, phrases, etc.) that are defined by a medical domain expert, and input to and stored in the predetermined library. The categories of concern correspond to issues (e.g., common issues) that may be of interest to users in the medical field, and particularly, to medical experts in an MCO-monitoring organization. For example, referring to the exemplary medical inquiries described above, entry of the medical inquiry “how often are patients visiting an emergency room?” may result in the identification of a category of concern entitled “emergency department utilization”, entry of the user inquiry “why is the readmission rate higher in the month of April compared to other months?” may result in the identification of a category of concern entitled “hospital readmissions”, entry of the user inquiry “how does the level of care for men in their forties compare to the level of care for men in their sixties?” may result in the identification of a category of concern entitled “demographic disparity in care”, and entry of the user inquiry “are patients with heart disease receiving adequate service?” may result in the identification of a category of concern entitled “chronic condition service utilization.”

According to exemplary embodiments, each category of concern is associated with one or more indicators reflecting the status of that category of concern. For example, the emergency department utilization rate of a hospital is an indicator for the category of concern “emergency department utilization.” The leading factors recommended by the system are factors that are highly correlated with the associated indicators, as those are the factors that statistically contribute to the movement of those associated indicators.

Different medical inquiries may result in the identification of the same category of concern. For example, the medical inquiries “why is the readmission rate so high?” and “why are there so many readmissions?” may result in the identification of a category of concern entitled “hospital readmissions.” In addition, multiple categories of concern may be identified for the same medical inquiry. For example, the medical inquiry “why is the readmission rate so high for men in their forties?” may result in the identification of a first category of concern entitled “hospital readmissions” and a second category of concern entitled “demographic disparity in care.”

Each category of concern stored in the predetermined library has at least one specific corresponding analytic module that calculates statistically significant findings, predictions, and recommendations for the corresponding category of concern. For example, referring to an emergency department utilization category of concern, a corresponding analytic module may measure the ratio of avoidable-to-non-avoidable emergency department visits for various populations, normalized emergency department visit comparisons, average emergency department cost comparisons, seasonal patterns of avoidable emergency department visits, and seasonal patterns of avoidable emergency department visits by major diagnostic analysis. As another example, referring to a demographic disparity in care category of concern, specific corresponding analytic modules may compare demographic data by ethnicity and/or compare geographic data by ethnicity.

As described above, the analytic modules corresponding to the categories of concern may be stored in a predetermined library stored in an electronic database (e.g., the same database that stores the predetermined library of categories of concern or a different database). Systems and methods according to exemplary embodiments may then access the analytic modules from the library. The analytic modules stored in the library are predefined analytic modules defined by a medical expert and designed to provide metrics for users to track the effectiveness and efficiency of MCOs, as described above. The analytic modules stored in the library may be updated by a medical expert. For example, new analytic modules may be added to the library, or existing analytic modules may be modified/updated or removed from the library.

Each analytic module stored in the library receives an input parameter(s), performs an analysis using the input parameters, and generates an output parameter(s) resulting from the analysis. The output parameter of an analytic module may correspond to a final, concrete recommendation that is provided to a user (e.g., a medical expert at an MCO-monitoring organization), or may be used as an input parameter for another analytic module. This process is referred to as constructing an analytic workflow, and is described in further detail below. Referring to the example above in which the category of concern is emergency department utilization and the corresponding analytic module calculates the ratio of avoidable-to-non-avoidable emergency department visits for various populations, the output of the analytic module may indicate that for type-2 diabetics, MCO1 has a ratio of 22% avoidable-to-non-avoidable emergency department visits, MCO2 has a ratio of 15% avoidable-to-non-avoidable emergency department visits, MCO3 has a ratio of 17% avoidable-to-non-avoidable emergency department visits, etc. According to systems and methods according to exemplary embodiments, the raw measurements may be tested for and reported with statistical relevance (e.g., p-values) and confidence intervals. For example, outliers that warrant further analysis may be specifically identified.

An exemplary health analytic module concerning geographic ethnicity comparison across the Native American population is illustrated in Table 1. The analysis assesses the total per-member-per-month (PMPM) cost of maintaining a Native American member as compared to all other ethnicities. Input parameters may include, for example, the reporting period of claims, specific chronic conditions, age group cohorts, etc. A ratio is determined for outspending or underspending on the population groups. Exemplary module output is shown in Table 1. Line 1 can be interpreted as: In Sierra County, MCO-1's ratio of PMPM spent on the American Indian population as compared to all other ethnicities is 10.49. The PMPM spending on the American Indian population is $2,015.44 and all other ethnicity PMPM spending is $192.04. The PMPM spending on the American Indian population of $2,015.44 in Sierra County is strongly above the population mean of $236.19.

TABLE 1

| | | | Non- | | Out- |
|---|---|---|---|---|---|
| | | Native_PMPM | Native_PMPM | County | spend |
| Ethnicity | MCO | ($) | ($) | Name | Ratio |
| American | MCO-1 | 2015.44 | 192.04 | Sierra | 10.49 |
| Indian | | | | | |
| American | MCO-3 | 1281.28 | 155.36 | De Baca | 8.24 |
| Indian | | | | | |
| American | MCO-3 | 667.63 | 170.97 | Roosevelt | 3.90 |
| Indian | | | | | |
| American | MCO-1 | 372.78 | 120.98 | Union | 3.08 |
| Indian | | | | | |
| American | MCO-4 | 701.56 | 228.27 | Eddy | 3.07 |
| Indian | | | | | |
| | | 1007.74 | 173.51 | | |

Referring again to FIG. 3, once a category of concern has been identified and selected based on the medical inquiry, leading factor(s) contributing to the category of concern are determined at block 303. As an example, leading factors that contribute to the readmission rate category of concern may include the type of disease of the patient, the age of the patient, and the ethnicity of the patient. In an exemplary embodiment, leading factors are extracted from various data sources. The leading factors may be extracted from the various data sources and aggregated into a library stored in an electronic database (e.g., the same database that stores the predetermined library of categories of concern or a different database). This library may be referred to as a contributing factors library. All of the factors stored in the contributing factors library may be referred to as contributing factors, and the factors from among the contributing factors that are determined to be highly correlated with the category of concern may be referred to as the leading factors (e.g., the leading factors are a subset of the contributing factors). Systems and methods according to exemplary embodiments may access the contributing factors from the contributing factors library. The contributing factors stored in the library may be updated in real-time as changes occur at the various data sources, or the contributing factors may be updated on a predetermined schedule to account for any changes occurring at the various data sources. Alternatively, the contributing factors may be retrieved directly from the various data sources as needed without first being extracted and aggregated into the contributing factors library.

The various data sources from which the contributing factors are retrieved may include, for example, data sources maintained by Medicaid offices, insurance companies, medical institutions such as hospitals, urgent care centers, and doctor's offices, etc. Examples of the types of data included in and retrieved from the various data sources include medical claim data including encounter claims, fee-for-service claims, capitation claims, member data, provider data, clinical data, lab data, disease data, risk scores, etc. Additional structured and unstructured data sources including data such as, for example, hospital data (e.g., financial data and operational data), health information exchange (HIE) data, electronic health record (EHR) data, clinical note data, compliance data, case management data, member socioeconomic data, member lifestyle data, and member feedback data may also be utilized. For example, when contributing factors are extracted from the various data sources and aggregated into the contributing factors library, data from the additional structured and unstructured data sources may be processed (e.g., cleaned, indexed, classified, etc.) and incorporated into the library. This may be implemented by, for example, performing batch processing or automated inline processing. Different actors (e.g., MCO-monitoring organizations, MCOs, patients, doctors, etc.) may have different levels of access to the library, including, for example, the ability to view and/or modify data stored in the library. The leading factors may be computed data from raw data (e.g. monthly average from daily spendings).

The contributing factors are a collection of character strings (e.g., words, phrases, etc.), and the leading factors are contributing factors that have been determined as contributing to the identified category of concern. For example, the leading factors may be variables that have been determined to be highly correlated with the category of concern identified at block 302.

The determination of the leading factors that contribute to the category of concern (e.g., which contributing factors are leading factors that are highly correlated with the category of concern) may be made using a statistical model analysis. A variety of statistical models may be used including, for example, a linear model, a generalized linear model such as a logistic regression model, a random forest model, etc. In an example using linear models, R-squared is used to determine the fit of a model. In an example using generalized linear models, such as logistic regression, deviance may be used to determine the fit of a particular model. In an exemplary embodiment, the factors may be determined using Analysis of Variance (ANOVA). The ANOVA process evaluates the fit of a set of models by adding one factor at a time to determine the importance of each additional factor. The factors may then be ranked based on the variance or deviance to identify the top factors (e.g., the leading factors that contribute to the category of concern). A pre-defined threshold value (e.g., a correlation threshold value) may be utilized as a cut-off point in determining which contributing factors are considered to be leading factors that contribute significantly to the category of concern, and which contributing factors are considered to be non-leading factors that do not significantly contribute to the category of concern. The value of the pre-defined threshold may be changed by a user (e.g., a medical domain expert). For example, the leading factors may be determined by assigning a correlation threshold value to the category of concern, ranking contributing factors existing in the contributing factors library using the ANOVA process, and selecting the contributing factors that have a higher ranking than the correlation threshold value as the leading factors.

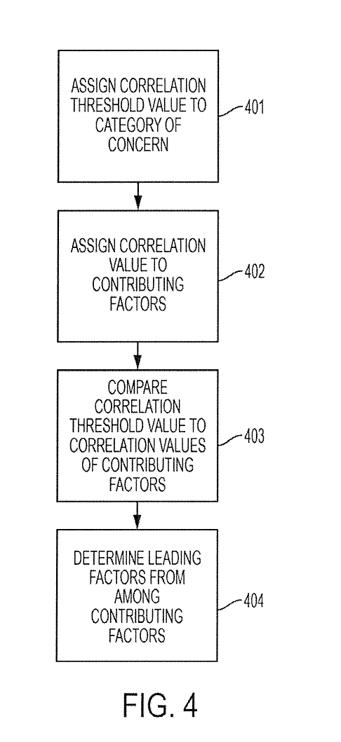

FIG. 4 is a flow diagram showing a process of determining the leading factors contributing to a category of concern according to an exemplary embodiment of the present disclosure.

Referring to FIG. 4, at block 401, a correlation threshold value is assigned to a category of concern. At block 402, a correlation value is assigned to all of the contributing factors stored in the contributing factors library in relation to the category of concern (e.g., the same contributing factors in the contributing factors library may have different correlation values assigned to them for different categories of concern). At block 403, the correlation value of the contributing factors stored in the contributing factors library is compared to the correlation threshold value of the category of concern. The leading factors are then determined from among the contributing factors at block 404. The leading factors are the contributing factors that have a correlation value higher than the correlation threshold value.

Referring again to FIG. 3, once the leading factors have been determined, the leading factors are used to recommend analytic modules and/or analytic workflows to be recommended to the user that will assist the user in discovering information relating to the category of concern indicated by the user's medical inquiry. As described above, each analytic module stored in the analytic modules library receives an input parameter(s), performs an analysis using the input parameters, and generates an output parameter(s) resulting from the analysis. Once the leading factors contributing to the category of concern have been determined at block 303, all of the analytic modules stored in the library that involve at least one of the leading factors are identified and selected. For example, all of the analytic modules stored in the predetermined library of analytic modules that receive at least one of the leading factors as an input parameter, or that produce at least one of the leading factors as an output parameter, are identified and selected at block 304.

At block 305, a recommendation responsive to the medical inquiry is generated. The recommendation may include a collection (e.g., a listing) of the individual identified analytic modules, and/or a constructed workflow including at least two of the identified analytic modules chained/linked together via respective input parameters and output parameters.

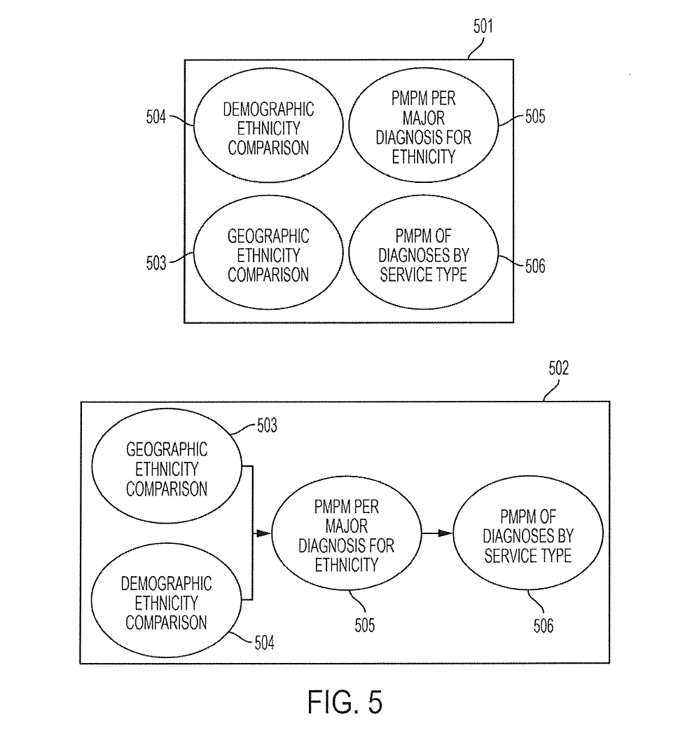

FIG. 5 shows an example of a recommendation provided in response to a medical inquiry according to exemplary embodiments of the present disclosure.

Referring to FIG. 5, the generated recommendation includes a listing 501 (e.g., an unordered listing) of individual analytic modules 503-506, and a constructed workflow 502 including analytic modules 503-506 chained together via their respective input and output parameters.

Referring to the listing 501, this portion of the generated recommendation indicates to the user the individual analytic modules (e.g., analytic modules 503-506) that are capable of outputting useful information relating to the user's medical inquiry. For example, each of the individual analytic modules in the listing 501 may be used separately by the user to obtain information relating to the user's medical inquiry. Each of the individual analytic modules in the listing 501 either receives one of the leading factors contributing to the category of concern as determined at block 303 as an input parameter, or outputs one of the leading factors determined at block 303 as an output parameter.

Referring to the constructed workflow 502, this portion of the generated recommendation is constructed using a sequence of the specifically identified analytic modules (e.g., analytic modules 503-506) that can provide findings, predictions, and recommendations for the medical inquiry. For example, a Medicaid director may ask the question:

What are the characteristics of the Medicaid members that drive the highest costs in my state?

A corresponding automated analytic workflow may reveal that:

Medium-risk members with type-2 diabetes are experiencing a high ratio of avoidable emergency department visits as compared to non-avoidable emergency department visits. Access to primary care in the top three counties is a major factor. Recommend increasing the number of primary care providers (PCPs) in these three countries.

Utilization of constructed workflows 502 allows for the generation of recommendations responsive to specific complex medical inquires, which may not be addressable by a single analytic module included in the listing 501. As a result, exemplary embodiments of the present disclosure promote the discovery and selection of flexible compositions of existing analytic modules and libraries to deliver more findings and insights, thereby providing improved decision support to users.

The constructed workflow 502 indicates to the user a specific workflow constructed from the identified analytic modules included in the listing 501 in the event that a composition(s) can be formed using the individual identified analytic modules based on their respective input and output parameters. For example, if the output parameter of one of the identified analytic modules is the same as an input parameter of at least another one of the identified analytic modules, a constructed workflow can be created in which the analytic modules are chained together into an automated analytic flow. The chaining is enabled by the encoding of knowledge of clinical decision-making into logical flows. In these logical flows, the findings of one specific analytic module may be fed as an input parameter(s) into a subsequent analytic module. This process is repeated until a concrete recommendation can be made to answer the medical inquiry. For example, the output generated the end of the constructed workflow corresponds to a concrete recommendation responsive to the user's medical inquiry. For convenience of explanation, FIG. 5 illustrates a single constructed workflow 502. However, the generated recommendation may also include a plurality of constructed workflows 502.

Referring to FIG. 5, assume that in an example, a user submits a medical inquiry relating to how to improve health outcomes for Native Americans in their state. In response to this medical inquiry, a plurality of analytic modules 503-506 are identified (see block 304 of FIG. 3). Each of the analytic modules 503-506 may include a description summarizing its respective function to the user. For example, analytic module 503 includes a description indicating that it performs a geographic ethnicity comparison, analytic module 504 indicates that it provides a demographic ethnicity comparison, analytic module 505 indicates that it relates to an analysis involving per-member-per-month (PMPM) major diagnosis in relation to ethnicity, and analytic module 506 indicates that it relates to an analysis involving PMPM diagnoses in relation to a service type. Based on these descriptions, the user may choose to either execute the individual analytic modules 503-506 included in the listing 501, or to execute the constructed analytic workflow 502.

Referring to the constructed workflow 502, analytic module 503 performs an analysis of geographic data by ethnicity, and analytic module 504 performs an analysis of demographic data by ethnicity. Analytic modules 503 and 504 are chained to analytic module 505 by using the output parameters of analytic modules 503 and 504, which identify problematic demographic and geographic Native American populations, as input parameters of analytic module 505. For example, the resulting populations (e.g., female Native Americans of ages 18-34) may be provided to analytic module 505, which uses this data to identify the top diagnoses driving the PMPM costs of those populations by ethnicity. The resulting diagnoses may then be provided from analytic module 505 to analytic module 506, which uses this data to identify which service types were utilized in those cases.

According to exemplary embodiments of the present disclosure, an analytic module that was not identified at block 304 may be used in the constructed workflow 502. These non-identified analytic modules may be referred to as intermediate analytic modules. Intermediate analytic modules are not directly related to the medical inquiry, but may be used to chain together two or more analytic modules identified at block 304 that would not otherwise be able to be chained together. For example, after analytic modules that receive or produce at least one of the leading factors have been identified at block 304, the analytic module library may be searched for intermediate analytic modules that can connect some of the analytic modules identified at block 304 to one another.

Since analytic modules may receive a number of input parameters and/or produce a number of output parameters, there may be many ways that two particular analytic modules can be connected to each other (i.e., via various different intermediate analytic modules). To improve the identification process in this event, in addition to storing individual analytic modules, the analytic module library may further store pre-defined constructed workflows that have been defined by a medical expert(s). If the two analytic modules that are being attempted to be chained together via intermediate analytic modules are included in any of the pre-defined constructed workflows, the pre-defined constructed workflows may be prioritized and may be included in the recommendation generated at block 305.

During construction of a workflow 502, an output of a first identified analytic module may be connected to an input of a second identified analytic module in response to determining that an output parameter corresponding to the output of the first identified analytic module and an input parameter corresponding to the input of the second identified analytic module are identical. An output of the second identified analytic module may then be connected to an input of a third identified analytic module in response to determining that an output parameter corresponding to the output of the second identified analytic module and an input parameter corresponding to the input of the third identified analytic module are identical. This process may be continuously repeated until all combinations including the analytic modules identified at block 304 have been exhausted. Intermediate analytic modules and pre-defined constructed workflows, which may or may not be included in the analytic module library according to exemplary embodiments, may or may not be utilized during construction of the workflow 502 according to exemplary embodiments of the present disclosure.

Regarding the recommendation and discovery of analytic modules and/or analytic workflows, it is noted that the amount and complexity of research and studies being performed in the medical field regarding population health are continuously increasing at a rapid pace. As a result, the number of analytic modules stored in analytic libraries used for the study of population health is rapidly increasing. As the size and complexity of the collection of these analytic modules grow, it becomes very difficult, or even impossible, for domain experts in the medical field to choose and use an appropriate analytic module, or a collection of appropriate analytic modules, using existing systems and methods that generate recommendations to solve problems relating to various categories of concern. That is, it has been becoming more difficult for domain experts to determine which analytic modules are capable of providing meaningful insight regarding a category of concern as the amount and complexity of analytic modules stored in an analytic module library continues to increase.

Some currently available systems and methods aim to provide some degree of assistance in discovering analytic modules relating to a category of concern, however, these systems and methods are very limited, as they are only capable of providing recommendations based solely on textual similarity. For example, using such existing systems and methods, when a user submits the medical inquiry “why is the re-admission rate so high”, the system and method will typically search an analytic module library and merely recommend all of the analytic modules that include the keywords “re-admission rate.” In this case, the system/method will typically recommend only analytic modules that calculate the re-admission rate, rather than the analytic modules that are useful in finding the causes contributing to the re-admission rate. That is, analytic modules that are useful in providing insight regarding the medical inquiry of “why is the re-admission rate so high” are not provided by existing systems and methods if such analytic modules do not include the keywords “re-admission rate.”

Exemplary embodiments of the present disclosure relate to technology used for searching analytic module libraries stored in a computer database to more efficiently identify and recommend an analytic module that provides insight relating to a specific category of concern upon receiving a medical inquiry. That is, systems and methods according to exemplary embodiments of the present disclosure are inextricably tied to the technology of electronically searching analytic module libraries stored in a computer database to identify and recommend an analytic module that provides insight relating to a specific category of concern upon receiving a medical inquiry. By providing systems and methods that are necessarily rooted in the computer technology field of searching large analytic libraries stored in an electronic computer database to identify and recommend analytic modules, in which such systems and methods expand upon the existing technology that merely provides recommendations based solely on textual similarity between an analytic module and a keyword in a medical inquiry, exemplary embodiments provide a solution that overcomes shortcomings specifically arising in the realm of the technology of electronically searching analytic module libraries stored in a computer database.

For example, exemplary embodiments of the present disclosure improve upon previous analytic module electronic database searching techniques by combining NLP and statistical modeling to intelligently interpret the meaning of a medical inquiry input by a user to identify and recommend an analytic module and/or an analytic workflow based on the interpreted meaning of the medical inquiry, rather than merely recommending an analytic module based on determining whether the analytic module and the medical inquiry simply include the same keyword. This is accomplished by injecting the clinical and business knowledge of medical domain experts into both a process of identifying a category of concern indicated by a medical inquiry using NLP, and subsequently determining leading factors that contribute to the identified category of concern using a statistical model analysis. By taking this approach, systems and methods capable of providing improved analytic module recommendations, which are not limited to basic keyword matching, are provided.

For example, since existing technology in this field is limited to recommending analytic modules using only keyword matching based on NLP techniques, existing technology is limited to providing analytic module recommendations based only on a literal interpretation of words included in the medical inquiry. In contrast, exemplary embodiments of the present disclosure translate the literal meaning of the medical inquiry into the underlying category of concern implied by the literal meaning using NLP, and subsequently perform a statistical analysis to determine leading factors correlated with the underlying category of concern to provide improvements to the process of identifying and recommending appropriate analytic modules in the computer technology field of searching large analytic libraries stored in an electronic computer database.

As would be understood by a person having ordinary skill in the art, the processes described herein cannot be performed by humans alone (or one operating with a pen and a pad of paper). Instead, such processes can only be performed by a machine. Specifically, processes such as data analysis, data security (such as encryption), electronic transmission of data over networks, etc., require the utilization of different specialized machines. For example, the automatic selection of a category of concern indicated by a natural language medical inquiry from a predetermined library of categories concern stored in an electronic database, the automatic determination of leading factors contributing to the category of concern using statistical model analysis, and the subsequent selection of analytic modules from a predetermined library of analytic modules stored in an electronic database that receive at least one of the leading factors as an input parameter or produce at least one of the leading factors as an output parameter cannot be performed manually (because it would take decades or lifetimes), and are integral with the processes performed by methods herein.

Further, such machine-only processes are not mere “post-solution activity” because each process determines a set of relevant findings based on medical data. The basis of these findings leads to the identification and selection of analytic modules and/or analytic workflows capable of providing information relating to an underlying category of concern indicated by a medical inquiry. Similarly, the selection and display of various analytic modules and/or various analytic workflows utilize special-purpose equipment (e.g., processors, routers, switches, etc.) that is distinct from a general-purpose processor. Also, the data selection and analysis is not mere post-solution activity because the data selection and analysis cannot be performed without the libraries of existing analytic modules. In other words, these various machines are integral with the methods herein because the methods cannot be performed without the machines (and cannot be performed by humans alone).

Additionally, the methods and systems herein solve many highly complex technological problems. For example, as described above, medical experts, such as those in MCO-monitoring organizations, suffer from the technological problem of not being fully capable to effectively identify and select a substantially complete set of analytic modules from a predetermined library of analytic modules that are able to generate useful data that provides insight responsive to a user's medical inquiry. Methods and systems herein solve this technological problem by identifying a category of concern indicated by a medical inquiry using NLP, subsequently determining leading factors that contribute to the identified category of concern using a statistical model analysis, and selecting analytic modules and/or analytic workflows from a predetermined library based on these leading factors (as opposed to based merely on keywords included in a user's medical inquiry, as implemented by existing computers in this technological field). This results in an improved computer capable of searching analytic libraries to produce a more complete set of analytic modules relating to a user's medical inquiry. This improves the efficiency of machines used by medical experts such as those in MCO-monitoring organizations, and reduces the amount of time and processing capability that an MCO-monitoring organization must utilize. By granting such benefits to MCO-monitoring organizations, the methods and systems herein reduce the amount and complexity of hardware and software needed to be purchased, installed, and maintained by MCO-monitoring organizations, thereby solving a substantial technological problem that MCO-monitoring organizations experience today. Accordingly, the technology of the user device used to implement the methods herein can be substantially simplified, thereby reducing cost, weight, size, etc., providing many substantial technological benefits to the user.

Further, the methods and systems herein are implemented by combining NLP and statistical model analysis using the explicit and unique approach described above, which has not been implemented by existing computers in the technological field of searching for and selecting analytic modules from analytic module libraries stored in an electronic database. Thus, the methods and systems described herein do not preempt the general field of searching for and selecting analytic modules from analytic libraries, since the methods and systems are limited to the sufficiently inventive concepts described herein, and are not necessary or obvious tools for achieving the selection of analytic modules from analytic libraries. That is, the inventive concepts that involve combining NLP and statistical modeling in the explicit manner described herein to identify a category of concern indicated by a medical inquiry, determine leading factors that contribute to the identified category of concern, and use the leading factors to select and recommend analytic modules from a predetermined library of analytic modules that provide insight relating to the underlying category of concern (e.g., by selecting analytic modules that receive at least one of the leading factors as an input parameter or produce at least one of the leading factors as an output parameter), are not necessary or obvious tools for selecting analytic modules from analytic libraries. Rather, these new and nonobvious inventive concepts provide an improved computer that produces a more complete set of analytic modules relating to a user's medical inquiry compared to existing computers in the technological field of selecting analytic modules from analytic libraries.

Referring to the improved computer provided be exemplary embodiments of the present disclosure that produces a more complete set of analytic modules relating to a user's medical inquiry compared to existing computers in the technological field of selecting analytic modules from analytic libraries, it is noted that the improved computer also uses less computer resources compared to existing computers in this technological field. For example, as described above, rather than searching for and selecting analytic modules and/or analytic workflows from a predetermined library based merely on keywords included in a user's medical inquiry, as implemented by existing computers in this technological field, exemplary embodiments provide an improved computer that first uses NLP to identify a category of concern indicated by a medical inquiry, subsequently determines leading factors that contribute to the identified category of concern using a statistical model analysis, and finally selects analytic modules and/or analytic workflows from a predetermined library based on these leading factors (rather than based merely on keywords in the medical inquiry).

By combining NLP and statistical model analysis in the manner described herein to determine leading factors contributing to a category of concern and selecting analytic modules and/or analytic workflows based on these leading factors—as opposed to merely extracting keywords in a medical inquiry using NLP and identifying all analytic modules and/or analytic workflows that include the extracted keywords, as implemented by existing computers in this technological field—exemplary embodiments result in an improved computer that requires less CPU cycles and less temporary data storage, since the improved computer is not required to select all analytic modules and/or analytic workflows including the extracted keywords, but rather, selects only the relevant analytic modules and/or analytic workflows that relate to the previously determined leading factors.

According to exemplary embodiments of the present disclosure, if the findings of an analytic module do not lead to a final/concrete recommendation responsive to a medical inquiry, a final/concrete recommendation may be obtained by performing further analysis. Such further analysis may be performed by utilizing an analytic workflow in which the findings of an analytic module are automatically sent to another analytic module for subsequent analysis, as described above. This process may be repeated using a plurality of analytic modules until a final/concrete recommendation is obtained. The identification and recommendation to a medical expert of such a workflow that is capable of providing a final/concrete recommendation to the medical expert's inquiry may positively affect population health outcomes and reduce costs.

According to exemplary embodiments of the present disclosure, when categories of concern are defined (e.g., by a medical expert), a connection between medical inquiries and certain variables (e.g., contributing factors) extracted from available data is established. The variables may be directly extracted from raw data or computed by data scientists. Thus, clinical/data science insights are injected into systems and methods according to exemplary embodiments. By combining categories of concern defined using clinical knowledge, NLP, and statistical modeling, systems and methods according to exemplary embodiments allow a medical expert to discover analytic modules and/or analytic workflows relating to the leading factors contributing to the user's medical inquiry, even when the medical expert is unaware of such leading factors and when such leading factors are not explicitly referenced in the user's medical inquiry.

As described above, exemplary embodiments of the present disclosure provide systems and methods that combine NLP and statistical modeling to determine the leading factors that significantly contribute to a medical inquiry. Exemplary embodiments further provide systems and methods capable of recommending an analytic modules(s) and/or an analytic workflow(s) based on the determined leading factors contributing to a medical inquiry rather than based merely on keyword matching. As a result, exemplary embodiments provide systems and methods that generate recommendations of an analytic module(s) and/or an analytic workflow(s) that provide additional insight and guidance for analyzing issues relating to an underlying category of concern implied by a literal medical inquiry submitted by a user.

Aspects of the present disclosure are described herein with reference to flowchart illustrations and/or block diagrams of methods, apparatuses (systems), and computer program products according to various systems and methods. It will be understood that each block of the flowchart illustrations and/or block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to further systems and methods herein, an article of manufacture is provided that includes a tangible computer readable medium having computer readable instructions embodied therein for performing the steps of the computer implemented methods, including the methods described above. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination thereof. Any of these devices may have computer readable instructions for carrying out the operations of the methods described above.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

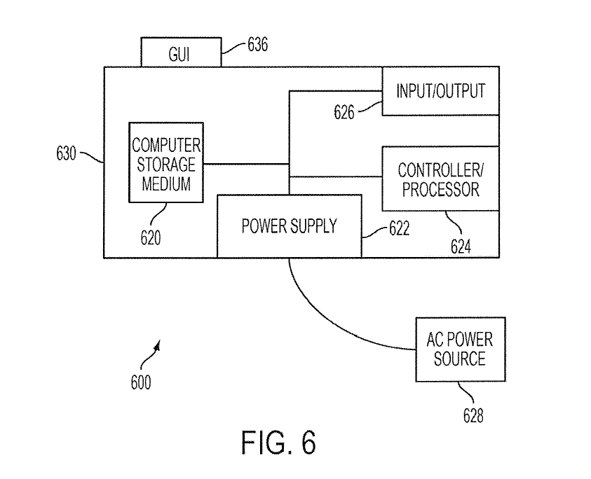

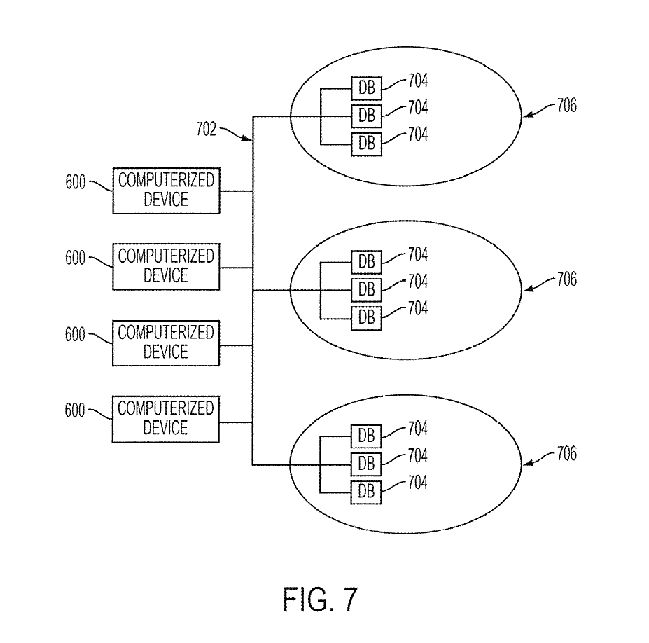

FIG. 6 illustrates a computerized device 600, which can be used with systems and methods herein and include, for example, a personal computer, a portable computing device, etc. The computerized device 600 includes a controller/processor 624 and a communications port (input/output device 626) operatively connected to the controller/processor 624. The controller/processor 624 may also be connected to a computerized network 702 external to the computerized device 600, such as shown in FIG. 7. In addition, the computerized device 600 can include at least one accessory functional component, such as a graphic user interface (GUI) assembly 636 that also operates on the power supplied from the external power source 628 (through the power supply 622).

The input/output device 626 is used for communications to and from the computerized device 600. The controller/processor 624 controls the various actions of the computerized device. A non-transitory computer storage medium 620 (which can be optical, magnetic, capacitor based, etc.) is readable by the controller/processor 624 and stores instructions that the controller/processor 624 executes to allow the computerized device 600 to perform its various functions, such as those described herein. Thus, as shown in FIG. 6, a body housing 630 has one or more functional components that operate on power supplied from the external power source 628, which may include an alternating current (AC) power source, to the power supply 622. The power supply 622 can include a power storage element (e.g., a battery) and connects to an external power source 628. The power supply 622 converts the external power into the type of power needed by the various components.

The computerized device 600 may be used to provide a graphical user interface (GUI) to the user that implements the methods described herein. For example, a provided GUI may include software providing a user with an entry field to enter his/her medical inquiry (e.g., via a display device operatively coupled to the computerized device 600). The GUI may subsequently display a generated recommendation responsive to the medical inquiry to the user, which may include a listing of analytic modules and/or a constructed workflow including analytic modules that can be used to provide insight relating to the medical inquiry, as described above. The GUI may further provide the user with an interface allowing the user to execute the identified analytic modules and/or constructed workflow to obtain a concrete/final recommendation responsive to the medical inquiry.

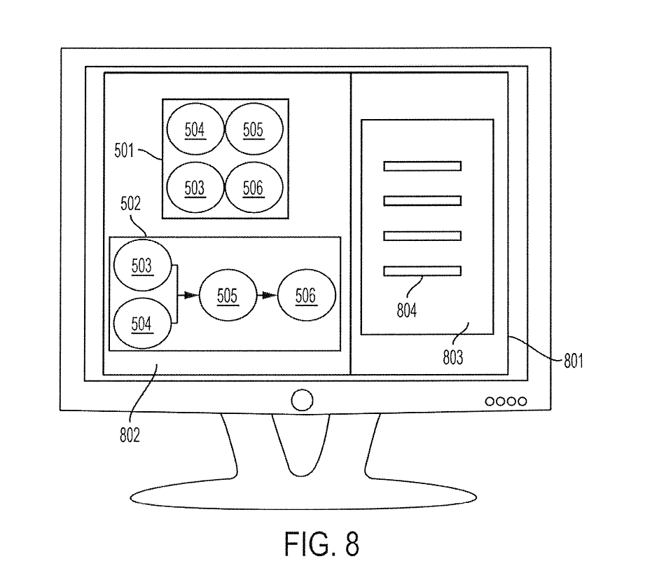

FIG. 8 shows an exemplary GUI accessible to a user according to an exemplary embodiment of the present disclosure.

As shown in FIG. 8, a user is presented with a GUI 801 including an output area 802 and an input area 803 including an input field(s) 804. The output area 802 displays the generated recommendation, which includes the listing 501 (e.g., an unordered listing) of individual analytic modules 503-506, and the constructed workflow 502 including analytic modules 503-506 chained together via their respective input and output parameters, as described in detail above with reference to FIG. 5. The input field(s) 804 allows the user to enter input such as, for example, the medical inquiry, in real-time, resulting in the generation of the recommendation displayed in the output area 802.

The user may execute at least one of the analytic modules included in the listing 501 displayed in the output area 802, or the user may execute the constructed workflow 502 displayed in the output area 802. The user may make such executions by, for example, clicking on (e.g., using a mouse), tapping on (e.g., using a touchscreen interface), etc., the desired analytic module included in the listing 501 or the constructed workflow 502. In response to the user's selection, a recommended action that results in improving a health outcome and/or reducing a medical service cost is generated using the selected analytic modules or the selected constructed workflow. The recommended action may be displayed to the user via the output area 802, and/or transmitted to an MCO (e.g., either directly to the MCO or to an MCO-monitoring organization, which can then transmit the recommended action to the MCO). Once received at the MCO, the MCO may implement the recommended action to improve a health outcome and/or reduce a medical service cost.

In case of implementing the systems and methods herein by software and/or firmware, a program constituting the software may be installed into a computer with dedicated hardware, from a storage medium or a network, and the computer is capable of performing various functions with various programs installed therein.

In the case where the above-described series of processing is implemented with software, the program that constitutes the software may be installed from a network such as the Internet or a storage medium such as the removable medium.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.), or a system combining software and hardware aspects that may all generally be referred to herein as a ‘circuit’, ‘module’, or ‘system.’ Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein.

Program code embodied on a computer readable medium may be transmitted using any appropriate medium, including, but not limited to, wireless, wireline, optical fiber cable, RF, etc., or any suitable combination thereof. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which includes one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As shown in FIG. 7, exemplary systems and methods herein may include various computerized devices 600 and databases 704 located at various different physical locations 706. The computerized devices 600 and databases 704 are in communication (operatively connected to one another) by way of a local or wide area (wired or wireless) computerized network 702. The various electronic databases and libraries described above may be included in one or more of the databases 704.

The terminology used herein is for the purpose of describing particular examples of the disclosed systems and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘includes’ and ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, or a combination thereof.

What is claimed is:

1. A computer system configured to perform at least one of improving a health outcome and reducing a medical service cost of a Managed Care Organization (MCO), the system comprising:
a memory storing a computer program; and
a processor configured to execute the computer program, wherein the computer program is configured to:
receive a medical inquiry from a user in real-time, wherein the medical inquiry comprises text data;
extract at least one keyword from the text data using natural language processing (NLP);
transmit the at least one keyword to a predetermined library of categories of concern;
compare the at least one keyword with a plurality of existing categories of concern stored in the predetermined library of categories of concern to select an existing category of concern indicated by the medical inquiry from the predetermined library of categories of concern;
determine leading factors contributing to the selected category of concern based on a statistical model analysis;
select analytic modules from a predetermined library of analytic modules that receive at least one of the leading factors as an input parameter or produce at least one of the leading factors as an output parameter; and
generate a recommendation comprising at least one of a listing of the selected analytic modules and a constructed workflow comprising at least two of the selected analytic modules chained together via respective input parameters and output parameters of the at least two selected analytic modules.

2. The computer system of claim 1, wherein the computer program is further configured to:
output the recommendation to a display;
execute at least one of the selected analytic modules included in the listing of the recommendation, or execute the constructed workflow of the recommendation, upon selection by the user, to generate a recommended action that results in at least one of improving the health outcome and reducing the medical service cost; and
transmit the recommended action to the MCO for implementation by the MCO.

3. The computer system of claim 1, wherein the computer program is configured to determine the leading factors by:
selecting the leading factors from a contributing factors library, wherein the leading factors are highly correlated with the selected category of concern.

4. The computer system of claim 1, wherein the computer program is further configured to:
assign a correlation threshold value to the selected category of concern;
assign a correlation value to contributing factors existing in a contributing factors library in relation to the selected category of concern; and
compare the correlation value of the contributing factors existing in the contributing factors library to the correlation threshold value of the selected category of concern,
wherein the leading factors determined to be contributing to the selected category of concern are contributing factors existing in the contributing factors library that have a correlation value higher than the correlation threshold value.

5. The computer system of claim 1, wherein the computer program is configured to determine the leading factors by:
assigning a correlation threshold value to the category of concern;
ranking contributing factors existing in a contributing factors library using an Analysis of Variance (ANOVA) process; and
selecting the leading factors from among the ranked contributing factors, wherein the selected leading factors have a higher ranking than the correlation threshold value.

6. The computer system of claim 1, wherein the computer program is configured to construct the constructed workflow by:
connecting an output of a first selected analytic module to an input of a second selected analytic module in response to determining that an output parameter corresponding to the output of the first selected analytic module and an input parameter corresponding to the input of the second selected analytic module are identical; and
connecting an output of the second selected analytic module to an input of a third selected analytic module in response to determining that an output parameter corresponding to the output of the second selected analytic module and an input parameter corresponding to the input of the third selected analytic module are identical.

7. The computer system of claim 1, wherein the leading factors are extracted from medical claim data comprising at least one of encounter claims, fee-for-service claims, capitation claims, member information, and provider information.

8. The computer system of 7, wherein the medical claim data further comprises at least one of financial hospital data, operational hospital data, health information exchange (HIE) data, electronic health record (EHR) data, clinical note data, compliance data, case management data, member socioeconomic data, member lifestyle data, and member feedback data.

9. The computer system of claim 1, wherein the selected category of concern comprises one of emergency department utilization, hospital readmissions, demographic disparity in care, and chronic condition service utilization.

10. The computer system of claim 1, wherein the leading factors are variables comprising at least one of a patient age group, a patient geographic location, and a patient ethnicity.

11. A computer system configured to perform at least one of improving a health outcome and reducing a medical service cost of a Managed Care Organization (MCO), the system comprising:
a memory storing a computer program; and
a processor configured to execute the computer program, wherein the computer program is configured to:
receive a medical inquiry from a user in real-time;
compare one or more keywords of the medical inquiry with a plurality of existing categories of concern stored in a categories of concern library to select a category of concern indicated by the medical inquiry;
select leading factors contributing to the selected category of concern from among a plurality of existing contributing factors stored in a contributing factors library based on a statistical model analysis;
select analytic modules from a predetermined library of analytic modules that receive at least one of the leading factors as an input parameter or produce at least one of the leading factors as an output parameter; and
generate a recommendation comprising at least one of a listing of the selected analytic modules and a constructed workflow comprising at least two of the selected analytic modules chained together via respective input parameters and output parameters of the at least two selected analytic modules.

12. The computer system of claim 11, wherein the computer program is further configured to:
output the recommendation to a display;
execute at least one of the selected analytic modules included in the listing of the recommendation, or execute the constructed workflow of the recommendation, upon selection by the user, to generate a recommended action that results in at least one of improving the health outcome and reducing the medical service cost; and
transmit the recommended action to the MCO for implementation by the MCO.

13. The computer system of claim 11, wherein the computer program is further configured to:
assign a correlation threshold value to the selected category of concern;
assign a correlation value to the plurality of existing contributing factors in relation to the selected category of concern; and
compare the correlation value of the plurality of existing contributing factors to the correlation threshold value of the selected category of concern,
wherein the leading factors selected as contributing to the selected category of concern are contributing factors stored in the contributing factors library that have a correlation value higher than the correlation threshold value.

14. The computer system of claim 11, wherein the computer program is configured to construct the constructed workflow by:
connecting an output of a first selected analytic module to an input of a second selected analytic module in response to determining that an output parameter corresponding to the output of the first selected analytic module and an input parameter corresponding to the input of the second selected analytic module are identical; and
connecting an output of the second selected analytic module to an input of a third selected analytic module in response to determining that an output parameter corresponding to the output of the second selected analytic module and an input parameter corresponding to the input of the third selected analytic module are identical.

15. The computer system of claim 11, wherein the leading factors are extracted from medical claim data comprising at least one of encounter claims, fee-for-service claims, capitation claims, member information, and provider information.

16. A computer system configured to perform at least one of improving a health outcome and reducing a medical service cost of a Managed Care Organization (MCO), the system comprising:
a memory storing a computer program; and
a processor configured to execute the computer program, wherein the computer program is configured to:
receive an inquiry from a user in real-time;
identify a category of concern indicated by the inquiry using natural language processing (NLP);
determine leading factors contributing to the category of concern based on a statistical model analysis;
select analytic modules from a predetermined library of analytic modules that receive at least one of the leading factors as an input parameter or produce at least one of the leading factors as an output parameter; and
generate a recommendation comprising at least one of a listing of the selected analytic modules and a constructed workflow comprising at least two of the selected analytic modules chained together via respective input parameters and output parameters of the at least two selected analytic modules.

17. The computer system of claim 16, wherein the computer program is further configured to:
output the recommendation to a display;
execute at least one of the selected analytic modules included in the listing of the recommendation, or execute the constructed workflow of the recommendation, upon selection by the user, to generate a recommended action that results in at least one of improving the health outcome and reducing the medical service cost; and
transmit the recommended action to the MCO for implementation by the MCO.

18. The computer system of claim 16, wherein the computer program is further configured to:
assign a correlation threshold value to the category of concern;
assign a correlation value to a plurality of existing contributing factors stored in a contributing factors library in relation to the category of concern; and
compare the correlation value of the plurality of existing contributing factors to the correlation threshold value of the category of concern,
wherein the leading factors determined to be contributing to the category of concern are contributing factors stored in the contributing factors library that have a correlation value higher than the correlation threshold value.

19. The computer system of claim 16, wherein the computer program is configured to construct the recommended workflow by:
connecting an output of a first selected analytic module to an input of a second selected analytic module in response to determining that an output parameter corresponding to the output of the first selected analytic module and an input parameter corresponding to the input of the second selected analytic module are identical; and
connecting an output of the second selected analytic module to an input of a third selected analytic module in response to determining that an output parameter corresponding to the output of the second selected analytic module and an input parameter corresponding to the input of the third selected analytic module are identical.

20. The computer system of claim 16, wherein the leading factors are extracted from medical claim data comprising at least one of encounter claims, fee-for-service claims, capitation claims, member information, and provider information.
